(19) United States
(12) Patent Application Publication
(10) Pub. No.: US 2020/0134435 A1
(43) Pub. Date: Apr. 30, 2020

(54) COMPUTATION APPARATUS, CIRCUIT AND RELEVANT METHOD FOR NEURAL NETWORK

(71) Applicant: SZ DJI TECHNOLOGY CO., LTD., Shenzhen (CN)

(72) Inventors: Qian GU, Shenzhen (CN); Mingming GAO, Shenzhen (CN); Tao LI, Shenzhen (CN)

(21) Appl. No.: 16/727,677

(22) Filed: Dec. 26, 2019

Related U.S. Application Data
(63) Continuation of application No. PCT/CN2017/108640, filed on Oct. 31, 2017.

(51) Int. Cl. G06N 3/063; G06N 3/04

(52) U.S. Cl. CPC G06N 3/063; G06N 3/04

(57) ABSTRACT

The present disclosure relates to a computation apparatus for a neural network. The computation apparatus includes a first processing unit and a second processing unit. The first processing unit is configured to perform a first computation on k1 number of input feature data according to a size of a computation window to obtain an intermediate result, where a size of the computation window is k1×k2, and k1 and k2 are positive integers. The second processing unit is configured to perform a second computation on k2 number of intermediate results output by the first processing unit according to the size of the computation window to obtain a computation result.

### CROSS-REFERENCE TO RELATED APPLICATION

The present disclosure is a continuation of International Application No. PCT/CN2017/108640, filed on Oct. 31, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of neural network and, more particularly, to a computation apparatus, circuit, and relevant method for a neural network.

### BACKGROUND

A convolutional neural network is formed by stacking multiple layers together. The result of a previous layer is an output feature map (OFM) that is used as the input feature map of a next layer. The output feature maps of the middle layers usually have many channels and the feature maps are relatively large. Due to the limitation of the on-chip system buffer size and bandwidth, when processing feature map data, the hardware accelerator of a convolutional neural network generally divides an output feature map into multiple feature map segments, and sequentially outputs each feature segment map. Each feature map segment is output in parallel in columns. For example, a complete output feature map is divided into 3 feature map segments, where each feature map segment is sequentially output in columns.

Currently, during image processing, line buffers are usually used to implement data input for convolution layer computations or pooling layer computations. The structure of the line buffer requires input data to be input in a rasterized order with rows (or columns) having a priority. Taking the height of a pooling window as k and the width of an input feature matrix W as an example, the line buffer needs to cache a depth of k*W. That is, the line buffer needs to cache input data with a size of k*W before the data is subjected to computation, which will increase the delay of data processing.

As can be seen above that the existing image processing solutions require a large buffer space and experience a long delay in data processing.

### SUMMARY

In accordance with the present disclosure, there is provided a computation apparatus for a neural network. The computation apparatus includes a first processing unit and a second processing unit. The first processing unit is configured to perform a first computation on k1 number of input feature data according to a size of a computation window to obtain an intermediate result, where a size of the computation window is k1×k2, and k1 and k2 are positive integers. The second processing unit is configured to perform a second computation on k2 number of intermediate results output by the first processing unit according to the size of the computation window to obtain a computation result.

Also in accordance with the disclosure, there is provided a circuit for processing a neural network. The circuit includes a first processing circuit and a second processing circuit. The first processing circuit is configured to perform a first computation on k1 number of input feature data according to a size of a computation window to obtain an intermediate result, where a size of the computation window is k1×k2, and k1 and k2 are positive integers. The second processing unit is configured to perform a second computation on k2 number of intermediate results output by the first processing circuit according to the size of the computation window to obtain a computation result.

Also in accordance with the disclosure, there is provided a method for processing a neural network. The method includes: performing a first computation on k1 number of input feature data according to a size of a computation window to obtain an intermediate result; and performing a second computation on k2 number of intermediate results obtained by the first computation according to the size of the computation window to obtain a computation result. Here, the size of the computation window is k1×k2, where k1 and k2 are both positive integers

### BRIEF DESCRIPTION OF THE DRAWINGS

FIG. 1 is a schematic diagram of a convolution layer computation for a neural network according to an embodiment of the present disclosure.

FIG. 2 is a schematic diagram of a pooling layer computation for a neuron network according to an embodiment of the present disclosure.

FIG. 3 is a schematic block diagram of a computing device for a neural network according to an embodiment of the present disclosure.

FIG. 4 is a schematic block diagram of a computing device for a neural network according to another embodiment of the present disclosure.

FIG. 5 is a schematic block diagram of a computing device for a neural network according to another embodiment of the present disclosure.

FIG. 6 is a schematic block diagram of a circuit for processing a neural network according to an embodiment of the present disclosure.

FIG. 7 is a schematic block diagram of a circuit for processing a neural network according to another embodiment of the present disclosure.

FIG. 8 is a flowchart of a method for processing a neural network according to an embodiment of the present disclosure.

### DETAILED DESCRIPTION OF THE EMBODIMENTS

For ease of understanding of the technical solutions provided in the present disclosure, convolutional layer computation and pooling layer computation in a convolutional neural network are first introduced as follows.

1) Convolution Layer Computation

The computation process of the convolution layer computation includes: sliding a fixed-size window across an entire image (which may be a feature map) plane; and performing a multiply-accumulate operation on the data covered by the window at each movement. In the convolutional layer computation, the step length of the window sliding is 1.

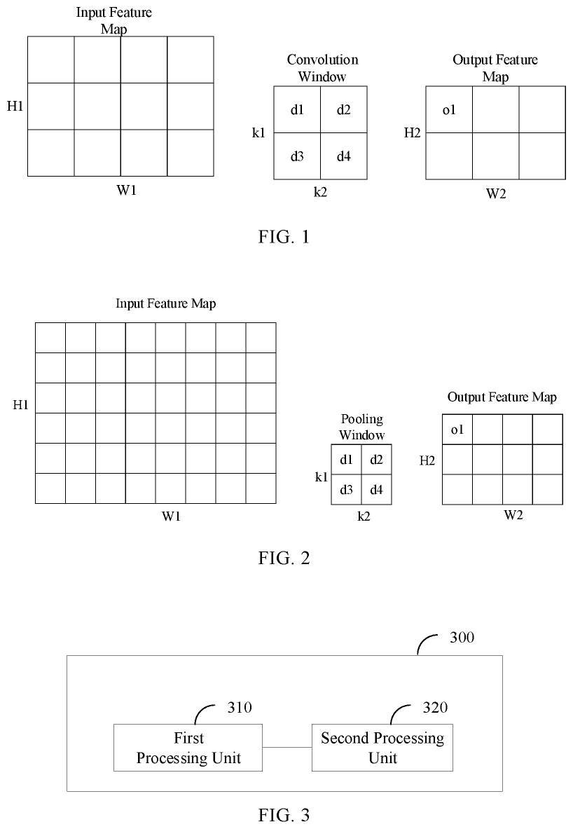

FIG. 1 is a schematic diagram of a convolution layer computation. The height H1 of the input image is 3 and the width W1 of the input image is 4. The height k1 of the convolution window is 2 and the width k2 of the convolution window is 2. The convolution layer computation includes: sliding the 2×2 convolution window on the 3×4 image at a time interval of the step length set as 1, performing a multiply-accumulate operation on the 4 data covered by each convolution window to obtain an output result, and constituting an output map based on all the output results. As shown in FIG. 1, the height H2 of the output map is 2 and the width W2 of the output map is 3.

The output o1 shown in FIG. 1 is obtained by the following formula:

o1=op{d1,d2,d3,d4},

where the computation mode of the operator op is a multiply-accumulate operation.

2) Pooling Layer Computation

The computation process of a pooling layer computation includes: sliding a fixed-size window across an entire image plane, performing a computation on the data covered in the window at each movement, to obtain a maximum value or an average value as the output. In the pooling layer computation, the step length of the window sliding is equal to the height (or width) of the window.

FIG. 2 is a schematic diagram of a pooling layer computation. The height H1 of the input image is 6 and the width W1 of the input data is 8. The height k1 of the pooling window is 2 and the width k2 of the pooling window is 2. The pooling layer computation includes sliding the 2×2 pooling window on the 6×8 image with a step length set as 2. The 4 data covered by each window will generate an output result, and all output results constitute an output map. As shown in FIG. 2, the height H2 of the output map is 3, and the width W2 of the output map is 4.

The output o1 shown in FIG. 2 is obtained by the following formula:

o1=op{d1,d2,d3,d4},

where the computation mode of the operator op is to find the maximum value (max) or the average value (avg), according to different configurations.

In the existing neural network computation processes (convolution layer computation or pooling layer computation), it usually “acquires the data out of the window first, and then compute”. Taking the pooling layer computation shown in FIG. 2 as an example, the four input data covered by the pooling window are obtained first, and then the four input data are computed.

In the present disclosure, the process of “acquiring the data out of the window first, and then computing” is decomposed into column computations and row computations.

Optionally, in one embodiment, the process of “acquiring the data out of the window first, and then computing” is decomposed into column computations first and then row computations.

Specifically, first, compute the data of a same column in the window to obtain an intermediate result. Then compute the intermediate results of all the columns in the window to obtain the computation result.

Taking the 2×2 window shown in FIG. 1 as an example, d1, d2, d3, and d4 are put into computation, and a result o1=op{d1, d2, d3, d4} is obtained. In the present disclosure, the operation o1=op{d1, d2, d3, d4} of the 2×2 window shown in FIG. 1 is decomposed into: first performing a column computation on d1 and d3 in a same column in the window to obtain an intermediate result p1=op1{d1, d3}, and performing a column computation on d2 and d4 in a same column in the window to get an intermediate result p2=op2{d2, d4}; then performing a row computation on the intermediate results p1 and p2 in all the columns to get a final computation result o1=op3{p1, p2}. Here, the computation mode of the operators op1 and op2 is a multiply-accumulate operation, and the computation mode of op3 is an accumulation operation.

Taking the 2×2 window shown in FIG. 2 as an example, d1, d2, d3, and d4 are put into computation, and a result o1=op{d1, d2, d3, d4} is obtained. In the present disclosure, the computation o1=op{d1, d2, d3, d4} of the 2×2 window shown in FIG. 2 is decomposed into: first performing a column computation on d1 and d3 in a same column in the window to obtain an intermediate result p1=op1 {d1, d3}, and performing a column computation on d2 and d4 in a same column in the window to get an intermediate result p2=op2{d2, d4}; then performing a row computation on the intermediate results p1 and p2 in all the columns to get a final computation result o1=op3 {p1, p2}. The computation modes of the operators op1, op2, and op3 are all to find the maximum value or average value.

Optionally, in one embodiment, the process of “acquiring the data out of the window first, and then computing” is decomposed into row computations first and then column computations.

Specifically, first, compute the data of a same row in the window to obtain an intermediate result; then compute the intermediate results of all the rows in the window to obtain the computation result.

It may be seen from the above that in the present disclosure, the window computation of the neural network is decomposed into column computations and row computations, so that as long as a row or a column of input data is received, the computation may be started. This does not require to first cache sufficient amount of two-dimensional input data before the computation may be started as the existing technologies do. Therefore, the delay of data processing may be effectively reduced. Meanwhile, the data caching mode may be flexibly configured according to the input method of the input data. For example, if the input data is input by column, the data is then cached by column, and the cached data is subjected to column computations first before a row computation. For another example, if the input data is input by row, the data is then cached by row, and the cached data is subjected to row computations first before a column computation.

A computation apparatus, circuit, and relevant method for a neural network provided in the present disclosure are described further in detail hereinafter.

FIG. 3 is a schematic block diagram of a computation apparatus 300 for a neural network according to an embodiment of the present disclosure. The computation apparatus 300 includes:

a first processing unit 310 that is configured to perform a first computation on k1 number of input feature data according to a size of the computation window to obtain an intermediate result, where the size of the computation window is k1×k2, and k1 and k2 are positive integers; and

a second processing unit 320 that is configured to perform a second computation on k2 number of intermediate results output by the first processing unit according to the size of the computation window to obtain a computation result.

Optionally, the first processing unit 310 is configured to perform a first computation on k1 number of input feature data for the input feature values in a column of the input feature matrix, where k1 represents the height of the computation window and k2 represents the width of the computation window. The second processing unit 320 is configured to perform a second computation on k2 number of intermediate results output by the first processing unit, that is, performing a second computation on the intermediate results of different columns of the window, to obtain the computation result.

In the disclosed embodiment, the first processing unit 310 may be referred to as a column processing unit, and correspondingly, the first computation is referred to as a column computation. The second processing unit 320 may be referred to as a row processing unit, and correspondingly, the second computation is referred to as a row computation.

Optionally, the first processing unit 310 is configured to perform a first computation on k1 number of input feature data for the input feature values in a row of the input feature matrix, where k1 represents the width of the computation window and k2 represents the height of the computation window. The second processing unit 320 is configured to perform a second computation on k2 number of intermediate results output by the first processing unit, that is, performing a second computation on the intermediate results of different rows, to obtain a computation result.

In the disclosed embodiment, the first processing unit 310 may be referred to as a row processing unit, and correspondingly, the first computation is referred to as a row computation. The second processing unit 320 may be referred to as a column processing unit, and correspondingly, the second computation is referred to as a column computation.

In the technical solutions provided by the present disclosure, the window computation of the neural network is decomposed into column computations and row computations, so that as long as a row or a column of input data is received, the computation may be started. In other words, the input feature matrix may be cached by row or by column, and may be computed simultaneously. There is no need to cache a sufficient amount of two-dimensional input data before the computation may be started as the existing technologies do. Therefore, the delay of data processing may be effectively reduced, and the data processing efficiency of the neural network may be effectively improved. At the same time, the storage resources may be saved, thereby saving the hardware resources.

The following description mainly uses “column processing first and then row processing” as an example, but the embodiments of the present disclosure are not limited thereto. Based on actual needs, the row processing may be performed prior to the column processing.

Optionally, in one embodiment, the computation window is a convolution window, the computation mode of the first computation is a multiply-accumulate operation, and the computation mode of the second computation is an accumulation operation.

Take the input image and the convolution window shown in FIG. 1 as an example, and take the “column computation first and then row computation” as an example. First, perform a column computation on d1 and d3 in a same column in the window to obtain an intermediate result p1=op1{d1, d3}, and perform a column computation on d2 and d4 in a same column in the window to obtain an intermediate result p2=op2{d2, d4}. Next, perform a row computation on the intermediate results p1 and p2 of all the columns in the window to obtain a final computation result o1=op3{p1, p2}. Here, the computation mode of the operators op1 and op2 is a multiply-accumulate operation, and the computation mode of op3 is an accumulation operation.

The disclosed embodiment may improve the convolution layer computation efficiency of the neural network.

Optionally, in one embodiment, the computation window is a pooling window, and the computation mode of the first computation is to find the maximum value or the average value. The computation mode of the second computation is the same as that of the first computation.

Take the input image and the pooling window shown in FIG. 2 as an example, and take the “column computation first and then row computation” as an example. First perform a column computation on d1 and d3 in a same column in the window to obtain an intermediate result p1=op1{d1, d3}, and perform a column computation on d2 and d4 in a same column in the window to obtain an intermediate result p2=op2{d2, d4}. Next, perform a row computation on the intermediate results p1 and p2 of all the columns to obtain a final computation result of =op3{p1, p2}. The computation modes of the operators op1, op2, and op3 are all to find the maximum value or average value.

The disclosed embodiment may improve the pooling layer computation efficiency of the neural network.

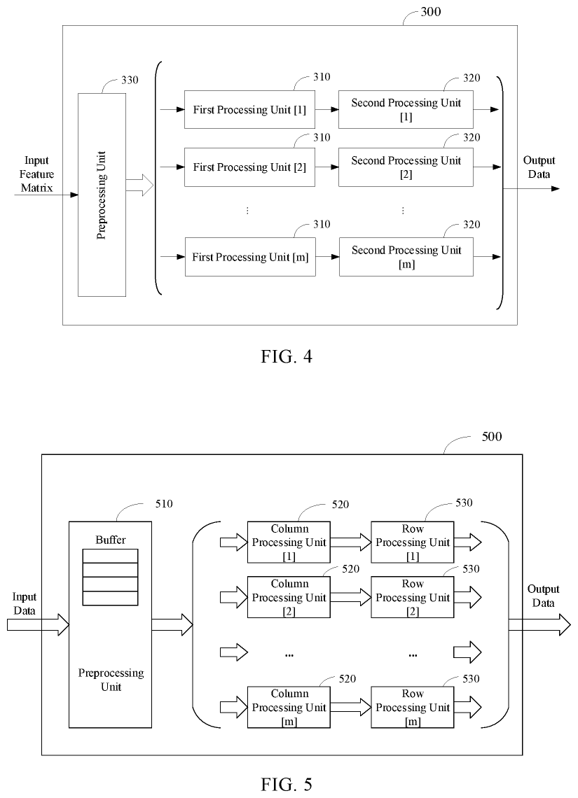

Optionally, as shown in FIG. 4, the computation apparatus includes M number of the first processing units 310 and M number of the second processing units 320. The M number of the first processing units 310 and the M number of the second processing units 320 have a one-to-one correspondence, where M is a positive integer greater than 1.

The computation apparatus 300 further includes:

a preprocessing unit 330 that is configured to receive the input feature matrix in columns, and process the received input feature values in a column according to the computation window to obtain M sets of data, where each set of data includes k1 number of input feature values. The preprocessing unit is also configured to input the M sets of data one-to-one into the M number of the first processing units.

Specifically, the preprocessing unit 330 receives a first column of input feature values in the input feature matrix, processes the received first column of input feature values into M sets of data, and inputs the processed M sets of data into the M number of the first processing units 310 for column processing, respectively. The M number of the first processing units 310 output M number of intermediate results. The M number of intermediate results are input one-to-one into the M number of the second processing units 320. The preprocessing unit 330 receives a second column of input feature values in the input feature matrix, processes the received second column of input feature values into M sets of data, and inputs the processed M sets of data into the M number of the first processing units 310 for column processing, respectively. The M number of the first processing units 310 output M number of intermediate results. The M number of intermediate results are input one-to-one into the M number of the second processing units 320. And so forth, until the preprocessing unit 330 receives the input feature values of the k2^{th}column. At this moment, the preprocessing unit 330 processes the received input feature values of the k2^{th} column into M sets of data, and inputs the processed M sets of data into the M number of the first processing units 310 for column processing, respectively. The M number of the first processing units 310 output M number of intermediate results, and the M number of intermediate results are input one-to-one into the M number of the second processing units 320. At this point, each of the M number of the second processing units 320 has received k2 number of intermediate results. Each second processing unit 320 performs a row computation on the received k2 number of intermediate results to obtain a computation result. That is, the M number of the second processing units 320 obtain M number of the computation results. Following that, the preprocessing unit 330 may continue to receive input feature values in columns, and repeat the above execution process to obtain the next M number of computation results. The specific details are not described again here.

As discussed earlier, in the existing technologies, an output feature map is usually divided into a plurality of feature map segments. Each feature map segment is sequentially output, and each feature map segment is output in parallel in columns. For example, a complete output feature map is divided into three feature map segments, and each feature map segment is sequentially output in columns. In the existing technologies, the data of the feature map segments is input by column, and the line buffer is input by row. That is, the data of the feature map segments is input in parallel, but the line buffer method is to process the data serially. This may cause input and output rates to mismatch, and thus the data throughput is too low. This may become the bottleneck of an accelerator and reduce the speed of the accelerator.

In the present disclosure, the preprocessing unit 310 receives a feature map segment in columns. The M number of the first processing units perform a column computation on the feature input values in a column for the feature map segment. The M number of the second processing units perform a row computation based on the M number of intermediate results output by the first processing units, to obtain the computation results of the feature map segment, that is, the result of the feature map segment processed by the neural network.

In the technical solutions provided by the present disclosure, a data caching mode may be flexibly configured according to an input method of the input data. For example, if input data is input by column, the data is cached by column, and the cached data is subjected to column computations before row computations. As another example, if input data is input by row, the data is cached by row, and the cached data is subjected to row computations prior to the column computations, thereby improving data throughput. At the same time, the computation apparatus provided in the disclosed embodiment may implement parallel processing of image data, thereby effectively improving the efficiency of data processing.

Optionally, in the disclosed embodiment, the number M, for the first processing units 310 and the second processing units 320 included in the computation apparatus 300, is determined according to the size of the input feature matrix and the size of the computation window.

Taking the computation window as a convolution window and that the first processing units 310 perform column processing and the second processing units 320 perform row processing as an example, if the number of rows of the input feature matrix is H, where H is an integer greater than or equal to k1, and the height of the convolution window is k1 and the width is k2, then M=H−(k1−1).

In the disclosed embodiment, the M sets of data include all the data in the input feature values of a column. That is, the computation apparatus 300 provided in the present disclosure may implement parallel processing of the input feature values in a column.

Taking the computation window as a pooling window and that the first processing units 310 perform column processing and the second processing units 320 performs row processing as an example, if the number of rows of the input feature matrix is H, where H is an integer greater than or equal to k1, and the height of the pooling window is k1 and the width is k2, then M=mod(H/k1).

When H is evenly divisible by k1, the M sets of data include all data in the input feature values in a column. That is, the computation apparatus 300 provided in the present disclosure may implement parallel processing of the input feature values in a column.

When H is not evenly divisible by k1, the M sets of data are part of the input feature values of the column. The preprocessing unit 330 then further includes a buffer. The preprocessing unit 330 is further configured to store the remaining data, other than the M sets of data in the input feature values of the column, in the buffer.

In the above scenario, the data of the last few rows of the input feature matrix needs to be cached in the buffer first, and then separately processed later.

For example, in a scenario where an output feature map is divided into multiple feature map segments, and each feature map segment is output in parallel in columns, if an output feature map is divided into 2 feature map segments, and the height of the first feature map segment is not evenly divisible by the height k1 of the pooling window, the last few rows of data of the first feature map segment are cached in the buffer first. When the input of the second feature map segment is valid, the cached data for the first feature map segment is read from the buffer, and is combined with the current data (i.e., the data of the second feature map segment) to form a new feature map segment, which is then re-mapped to the M number of the first processing units 310 for processing.

FIG. 5 is a schematic block diagram of a computation apparatus 500 for a neural network according to an embodiment of the present disclosure. The computation apparatus 500 includes a preprocessing unit 510, M number of column processing units 520, and M number of row processing units 530, where the M number of column processing units 520 and the M number of row processing units 530 have a one-to-one correspondence.

The preprocessing unit 510 is configured to receive input data, preprocess the input data according to the computation window to obtain M sets of data, where each set of data includes k2 number of input feature values, and input the M sets of data one-to-one into M number of column processing units, where the height of the computation window is k1 and the width is k2.

Specifically, that the preprocessing unit 510 is configured to receive input data specifically includes that the preprocessing unit 510 receives the input feature matrix in columns.

A column processing unit 520 is configured to perform a column computation on the input k2 number of input feature values to obtain an intermediate result, and input the intermediate result into a corresponding row processing unit 530.

Specifically, for a pooling layer computation, a column computation means to find a maximum value or an average value. For a convolutional layer computation, a column computation refers to a multiply-accumulate operation.

A row processing unit 530 is configured to cache the intermediate results output by the corresponding column processing unit 520. Whenever there are k2 number of intermediate results received, perform a row computation on k2 number of intermediate results to obtain a computation result.

Specifically, for a pooling layer computation, the computation mode corresponding to the row computation is the same as the computation mode corresponding to the column computation. For a convolutional layer computation, a row computation refers to an accumulation operation.

As shown in FIG. 5, the computation results of the M number of row processing units 530 constitute output data of the computation apparatus 500.

Optionally, in the disclosed embodiment, the input data received by the preprocessing unit 510 is a feature map segment obtained from a to-be-processed input feature map.

Optionally, in some embodiments, the number M, for the column processing units 520 and the row processing units 530, is determined according to the size of the input feature matrix received by the preprocessing unit 510 and the size of the computation window.

Specifically, the input feature matrix is a feature map segment.

Assume that a complete input feature map is divided into several feature map segments. The preprocessing unit 510 is configured to sequentially receive the feature map segments.

Under certain circumstances, a sliding window (e.g., a computation window) may cover part of the data of both a previous feature map segment and a subsequent feature map segment. At this moment, the preprocessing unit 510 is configured to cache the last few rows of data, of the previous feature map segment in the window, in the buffer of the preprocessing unit 510 (as shown in FIG. 5). When the input of the subsequent feature map segment is valid, the cached data is read from the buffer, and is combined with the current data (that is, the current input feature map segment) to form a new feature map segment. The new feature map segment is re-mapped to the M number of column processing units 520.

In the disclosed embodiment, buffer space may be effectively saved, and the hardware resources may be saved.

For example, taking an input feature map with a height of 6 and a width of 8 and a pooling window with a size of 2×2 and a step length of 2 as an example as shown in FIG. 2, each column processing unit 520 in FIG. 5 may process two rows of data in a same column, each row processing unit 530 may process two columns of data in a same row. The computation apparatus shown in FIG. 5 only needs to configure three column processing units 520 and three row processing units 530.

For another example, assume that the input feature map is divided into two feature map segments segment 1 and segment 2, and the height h of segment 1 and segment 2 is 14, the pooling window size is 3×3 and the step length is 2. When the preprocessing unit 510 processes segment 1, it needs to cache the last two rows of segment 1 into the buffer first. After receiving the segment 2, the cached two rows of segment 1 are combined with the 14 rows of segment 2 into a new feature map segment with a height of 16, which is then re-mapped into the column processing units 520.

In the present disclosure, the window computation of the neural network is decomposed into column computations and row computations, so that as long as a row or a column of input data is received, the computation may be started. The computation does not require to cache a sufficient amount of two-dimensional input data before the computation may be started as the existing technologies do. Therefore, the delay of data processing may be effectively reduced, and real-time data processing may be achieved. At the same time, the data caching mode may be flexibly configured according to the input method of the input data. For example, if the input data is input by column, the data is cached by column, and the cached data is subjected to column computations before row computations. For another example, if the data is input by row, the data is cached by row, and the cached data is subjected to row computations before column computations. In addition, the computation apparatus provided in the present disclosure requires less buffer space than the existing technologies, thereby saving hardware overhead. The computation apparatus provided in some embodiments may implement parallel processing of multiple window computations, thereby improving the data throughput and overcoming the bottleneck of a neural network accelerator.

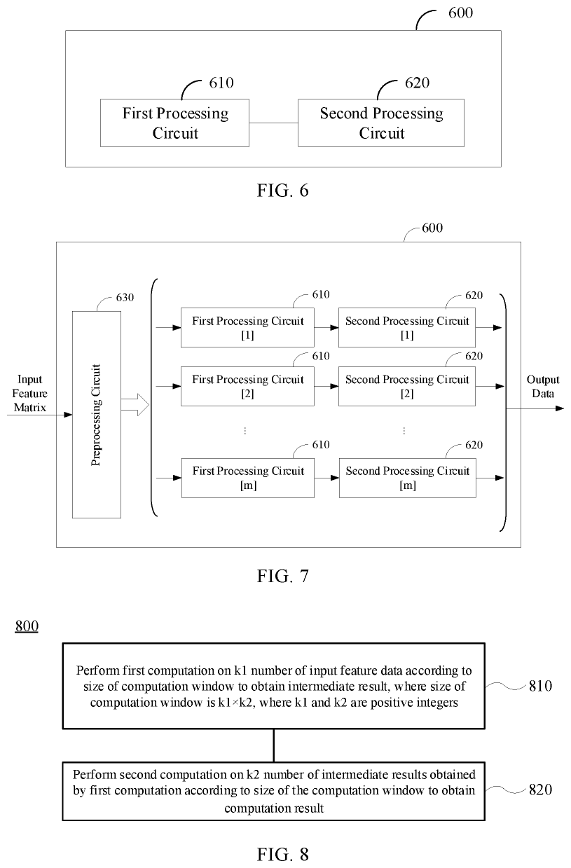

FIG. 6 further illustrates a circuit 600 for processing a neural network according to an embodiment of the present disclosure. The circuit 600 may correspond to the computation apparatus 300 or 500 provided in the disclosed embodiments. As shown in FIG. 6, the circuit 600 includes:

a first processing circuit 610 that is configured to perform a first computation on k1 number of input feature data according to a size of a computation window to obtain an intermediate result, where the size of the computation window is k1×k2, and k1 and k2 are positive integers; and

a second processing circuit 620 that is configured to perform a second computation on k2 number of intermediate results output by the first processing circuit according to the size of the computation window to obtain a computation result.

Optionally, the first processing circuit 610 is configured to perform a first computation on k1 number of input feature data for the input feature values in a column of the input feature matrix, where k1 represents the height of the computation window and k2 represents the width of the computation window. The second processing circuit 620 is configured to perform a second computation on k2 number of intermediate results output by the first processing circuit 610, that is, perform a second computation on the intermediate results of different columns to obtain a computation result.

In the above described embodiment, the first processing circuit 610 may be referred to as a column processing circuit, and correspondingly, the first computation is referred to as a column computation. The second processing circuit 620 may be referred to as a row processing circuit, and correspondingly, the second computation is referred to as a row computation.

Optionally, the first processing circuit 610 is configured to perform a first computation on k1 number of input feature data for input feature values in a row of the input feature matrix, where k1 represents a width of the computation window and k2 represents a height of the computation window. The second processing circuit 620 is configured to perform a second computation on k2 number of intermediate results output by the first processing circuit, that is, perform a second computation on the intermediate results of different rows to obtain a computation result.

In the above described embodiment, the first processing circuit 610 may be referred to as a row processing circuit, and correspondingly, the first computation is referred to as a row computation. The second processing circuit 620 may be referred to as a column processing circuit, and correspondingly, the second computation is referred to as a column computation.

In the technical solutions provided by the present disclosure, the window computation of the neural network is decomposed into column computations and row computations, so that as long as a row or a column of input data is received, the computation may be started. In other words, the input feature matrix may be cached by row or by column, and may be computed at the same time. There is no need to cache a sufficient amount of two-dimensional input data before the computation may be started as the existing technologies do. Therefore, the delay of data processing may be effectively reduced, and data processing efficiency of the neural network may be effectively improved. Meanwhile, the storage resources are saved, thereby saving the hardware resources.

Optionally, in some embodiments, the computation window is a convolution window, the computation mode of the first computation is a multiply-accumulate operation, and the computation mode of the second computation is an accumulation operation.

Optionally, in some embodiments, the computation window is a pooling window, the computation mode of the first computation is to find the maximum value or the average value, and the computation mode of the second computation is the same as the computation mode of the first computation.

Optionally, as shown in FIG. 7, in one embodiment, the circuit 600 includes M number of first processing circuits 610 and M number of second processing circuits 620. The M number of first processing circuits 610 and the M number of second processing circuits 620 have a one-to-one correspondence, and M is a positive integer greater than 1. The circuit 600 further includes a preprocessing circuit 630 that is configured to receive the input feature matrix in columns, and process the received input feature values in a column according to the computation window to obtain M sets of data, where each set of data includes k1 number of input feature values. The preprocessing circuit 630 is further configured to input the M sets of data one-to-one into the M number of first processing circuits 610.

Specifically, the preprocessing circuit 630 receives a first column of input feature values in the input feature matrix, processes the received input feature values into M sets of data, and inputs the processed M sets of data into the M number of first processing circuits 610 for column processing, respectively. The M number of first processing circuits 610 output M number of intermediate results, and the M number of intermediate results are input one-to-one into the M number of second processing circuits 620. The preprocessing circuit 630 receives a second column of input feature values in the input feature matrix, processes the received input feature values into M sets of data, and inputs the processed data into the M number of first processing circuits 610 for column processing, respectively. The M number of first processing circuits 610 output M number of intermediate results, and the M number of intermediate results are input one-to-one into the M number of second processing circuits 620. And so forth, until the preprocessing circuit 630 receives the input feature values of the k2^{th} column. At this moment, the preprocessing circuit 630 processes the received input feature values of the k2^{th} into M sets of data, and inputs the processed data into the M number of first processing circuits 610 for column processing, respectively. The M number of first processing circuits 610 output M number of intermediate results, and input the M number of intermediate results one-to-one into the M number of second processing circuits 620. At this point, each of the M number of second processing circuits 620 has received k2 number of intermediate results, and each second processing circuit 620 performs a row computation on the received k2 number of intermediate results to obtain a computation result. That is, the M number of second processing circuits 620 obtain M number of computation results. Later, the preprocessing circuit 630 may continue to receive the input feature values in columns and repeat the process described above to obtain the next M number of computation results, details of which are not repeated here.

In the present disclosure, the preprocessing circuit 610 receives a feature map segment in columns. The M number of first processing circuits perform a column computation on the feature input values in a column of the feature map segment. The M number of second processing circuits perform a row computation according to the intermediate results output by the M number of first processing circuits, to obtain computation results of the feature map segment, that is, the result of the feature map segment processed by the neural network.

In the technical solutions provided by the present disclosure, a data caching mode may be flexibly configured according to an input method of input data. For example, if input data is input by column, the data is cached by column, and the cached data is subjected to column computations before row computations. As another example, if input data is input by row, the data is cached by row, and the cached data is subjected to row computations before column computations, thereby improving data throughput. At the same time, the computation apparatus provided in the disclosed embodiment may implement parallel processing of image data, thereby effectively improving the efficiency of data processing.

Optionally, in the disclosed embodiment, the number M, for the first processing circuit 610 and the second processing circuit 620 included in the computation apparatus 300, is determined according to the size of the input feature matrix and the size of the computation window.

Taking the computation window as a convolution window, and that the first processing circuits 610 perform column processing and the second processing circuits 620 perform row processing as an example, if the number of rows of the input feature matrix is H, where H is an integer greater than or equal to k1, and the height of the convolution window is k1 and the width is k2, then M=H−(k1−1).

In some embodiments, the M sets of data include all the data in the input feature values of the column. That is, the computation apparatus 300 provided in the present disclosure may implement parallel processing of the input feature values in the column.

Taking the computation window as a pooling window, and that the first processing circuits 610 perform column processing and the second processing circuits 620 perform row processing as an example, if the number of rows of the input feature matrix is H, where H is an integer greater than or equal to k1, and the height of the convolution window is k1 and the width is k2, then M=mod(H/k1).

When H is evenly divisible by k1, the M sets of data include all data in the input feature values of the column. That is, the computation apparatus 300 provided in the present disclosure may implement parallel processing of the input feature values in the column.

In the above-described embodiment, the M sets of data include all data in the input feature values of the column.

When H is not evenly divisible by k1, the M sets of data are part of the input feature values in the column. The preprocessing circuit 630 further includes a buffer, and the preprocessing circuit 630 is further configured to store the remaining data, other than the M sets of data in the input feature values of the column, in the buffer.

In the above-descried embodiment, the M sets of data are part of the input feature values of the column. In this scenario, the data of the last few rows of the input feature matrix needs to be cached in the buffer first, and then processed later.

For example, in a scenario where an output feature map is divided into multiple feature map segments, and each feature map segment is output in parallel in columns, if an output feature map is divided into 2 feature map segments, and the height of the first feature map segment is not evenly divisible by the height k1 of the pooling window, the last few rows of data of the first feature map segment is cached in the buffer first. When the input of the second feature map segment is valid, the cached data is read from the buffer, and combined with the current data (i.e., the data of the second feature map segment) to form a new feature map segment and re-mapped to the M number of first processing circuits 610 for processing.

In the technical solutions provided by the present disclosure, a data caching mode may be flexibly configured according to an input method of input data. For example, if input data is input by column, the data is cached by column, and the cached data is subjected to column computations before row computations. As another example, if input data is input by row, the data is cached by row, and the cached data is subjected to row computations before column computations, thereby improving data throughput. At the same time, the computation apparatus provided in the disclosed embodiment may implement parallel processing of image data, thereby effectively improving the efficiency of data processing.

Optionally, in some embodiments, the input feature matrix represents a feature map segment of a to-be-processed image (which may be a to-be-processed feature map). The preprocessing circuit 630 is specifically configured to sequentially receive each feature map segment of the to-be-processed image.

Optionally, the circuit 600 further includes a communication interface, which is configured to receive to-be-processed image data and is also configured to output computation results of the second processing circuits, that is, output map data.

In summary, the technical solutions provided by the present disclosure breaks the window computation of the neural network into column computations and row computations. This allows the computation to be started as long as a row or a column of input data is received, but does not require to cache a sufficient amount of two-dimensional input data before the computation may be started as the existing technologies do. Therefore, the delay of data processing may be effectively reduced, and real-time data processing may be realized. Meanwhile, the data caching mode may be flexibly configured according to the input method of the input data. For example, if the input data is input by column, the data is cached by column, and the cached data is subjected to column computations before row computations. For another example, if the input data is input by row, the data is cached by row, and the cached data is subjected to row computations before column computations. In addition, the computation apparatus provided in the present disclosure requires less buffer space than the existing technologies, thereby saving hardware overhead. The computation apparatus provided in some embodiments may implement parallel processing of multiple window computations, thereby improving the data throughput and overcoming the bottleneck of a neural network accelerator.

FIG. 8 further illustrates a method 800 for processing a neural network according to an embodiment of the present disclosure. Optionally, the method 800 may be executed by the computation apparatus provided in the disclosed embodiments, and the descriptions of the technical solutions and technical effects in each of the foregoing embodiments may be applied to this embodiment. For the sake of brevity, these technical solutions and technical effects are not described again. As shown in FIG. 8, the method 800 includes the following steps.

Step 810: Perform a first computation on k1 number of input feature data according to the size of the computation window to obtain an intermediate result, where the size of the computation window is k1×k2, where k1 and k2 are positive integers.

Specifically, Step 810 may be performed by the first processing unit 310 in the disclosed embodiments.

Step 820: Perform a second computation on k2 number of intermediate results obtained by the first computation according to the size of the computation window to obtain a computation result.

Specifically, Step 820 may be performed by the second processing unit 320 in the disclosed embodiments.

In the technical solutions provided by the present disclosure, the window computation of the neural network is decomposed into column computations and row computations, so that as long as a row or a column of input data is received, the computation may be started. In other words, the input feature matrix may be cached by row or by column and may be computed at the same time. There is no need to cache a sufficient amount of two-dimensional input data before the computation may be started as the existing technologies do. Therefore, the delay of data processing may be effectively reduced, and the data processing efficiency of the neural network may be effectively improved. Meanwhile, the storage resources may be saved, thereby saving the hardware resources.

Optionally, in the disclosed embodiment, the method 800 further includes: receiving the input feature matrix in columns, and processing the received input feature values in a column according to the computation window to obtain M sets of data, where each set of data includes k1 number of input feature values. Step 810 specifically includes: performing a first computation on the M sets of data according to the size of the computation window to obtain the corresponding intermediate results. Specifically, the M number of the first processing units 310 in the disclosed embodiments may respectively perform a first computation on the M sets of data to obtain corresponding intermediate results. Step 820 specifically includes: each time k2 number of intermediate results are obtained from the first computation corresponding to each of the M sets of data, the second computation is performed to obtain a corresponding computation result. Specifically, the M number of the second processing units 320 in the disclosed embodiments may respectively perform a second computation on the M sets of data to obtain the corresponding intermediate results.

In the technical solutions provided in the present disclosure, parallel processing of image data may be achieved, thereby effectively improving the efficiency of data processing.

Optionally, in the disclosed embodiment, the value of M is determined based on the size of the input feature matrix and the size of the computation window.

Optionally, in the disclosed embodiment, the M sets of data include all data in the input feature values of a column.

Optionally, in the disclosed embodiment, the M sets of data are part of the input feature values of a column. The method 800 further includes: storing the remaining data, other than the M sets of data in the input feature values of the column, into a buffer.

Optionally, in the disclosed embodiment, the computation window is a convolution window, the computation mode of the first computation is a multiply-accumulate operation, and the computation mode of the second computation is an accumulation operation.

Optionally, in the disclosed embodiment, the computation window is a pooling window, the computation mode of the first computation is to find the maximum value or the average value, and the computation mode of the second computation is the same as that of the first computation.

Optionally, in the disclosed embodiment, the input feature matrix represents a feature map segment in a to-be-processed image, and receiving the input feature matrix by column includes: sequentially receiving each feature map segment of the to-be-processed image.

An embodiment of the present disclosure further provides a computer-readable storage medium storing a computer program that, when executed by a computer, causes the computer to implement: performing a first computation on k1 number of input feature data according to a size of a computation window, to obtain an intermediate result, where the size of the computation window is k1×k2, and k1 and k2 are both positive integers; and, according to the size of the computation window, performing a second computation on k2 number of intermediate results obtained by the first computation to obtain a computation result.

The descriptions of the technical solutions and technical effects in each of the foregoing embodiments may be applied to the current embodiment. For the sake of brevity, details are not repeated here.

Optionally, in the disclosed embodiment, when the computer program is executed by the computer, the computer program is also configured to implement: receiving an input feature matrix in columns, and processing the received input feature values in a column according to the computation window to obtain M sets of data, where each set of data includes k1 number of input feature values. Where performing a first computation on the k1 number of input feature data according to the size of the computation window to obtain an intermediate result includes: according to the size of the computation window, performing the first computation on the M sets of data to obtain corresponding intermediate results. Where, according to the size of the computation window, performing the second computation on the k2 number of intermediate results obtained by the first computation to obtain the computation result includes: each time k2 number of intermediate results are obtained from the first computation corresponding to each of the M sets of data, performing the second computation, to obtain a corresponding computation result.

Optionally, in the disclosed embodiment, the value of M is determined based on the size of the input feature matrix and the size of the computation window.

Optionally, in the disclosed embodiment, the M sets of data include all data in the input feature values in a column.

Optionally, in the disclosed embodiment, the M sets of data are part of the input feature values in a column. When the computer program is executed by a computer, the computer program is also configured to implement: storing the remaining data, other than the M sets of data in the input feature values of the column, in the buffer.

Optionally, in the disclosed embodiment, the computation window is a convolution window, the computation mode of the first computation is a multiply-accumulate operation, and the computation mode of the second computation is an accumulation operation.

Optionally, in the disclosed embodiment, the computation window is a pooling window, the computation mode of the first computation is to find the maximum value or the average value, and the computation mode of the second computation is the same as that of the first computation.

Optionally, in the disclosed embodiment, the input feature matrix represents a feature map segment of a to-be-processed image. Where receiving the input feature matrix in columns includes sequentially receiving each feature map segment of the to-be-processed image.

The present disclosure is applicable to a convolutional neural network (CNN) hardware accelerator. The application method is an IP core. The disclosure may also be applied to other types of neural network accelerators/processors that include a pooling layer.

The foregoing embodiments may be implemented in whole or in part by software, hardware, firmware, or any other combinations thereof. When implemented in software, it may be implemented in whole or in part in the form of a computer program product. The computer program product includes one or more computer instructions. When the computer program instructions are loaded and executed on the computer, the processes or functions according to the embodiments of the present invention are wholly or partially implemented. The computer may be a general-purpose computer, a special-purpose computer, a computer network, or other programmable devices. The computer instructions may be stored in a computer-readable storage medium or transmitted from one computer-readable storage medium to another computer-readable storage medium. For example, the computer instructions may be transmitted from a website, computer, server, or data center to another website, computer, server, or data center via wired (such as coaxial cable, optical fiber, digital subscriber line (DSL), etc.) or wireless (such as infrared, wireless, microwave, etc.) transmission. The computer-readable storage medium may be any available medium that can be accessed by a computer or a data storage device such as a server, a data center, or the like that includes one or more available medium integrated therein. The available medium may be a magnetic medium (e.g., a floppy drive, a hard drive, a magnetic disc, etc.), an optical medium (e.g., a digital video disc (DVD)), or a semiconductor medium (e.g., a solid-state drive (SSD)), etc.

Those of ordinary skill in the art may appreciate that the units and computation steps of each example described in conjunction with the embodiments disclosed herein may be implemented by electronic hardware or a combination of computer software and electronic hardware. Whether these functions are implemented in hardware or software depends on the specific applications and design constraints of the disclosed technical solutions. A person skilled in the art may apply other methods to implement the described functions for each specific application, but such implementations are not to be considered to be out of the scope of the present disclosure.

In the foregoing embodiments provided in the present disclosure, it should be understood that the disclosed apparatus may be implemented in other ways. For example, the aforementioned apparatus embodiments are merely schematic. For example, the division of the units is only a logical function division. In actual implementations, there may be other ways for the division of the units. For example, multiple units or components may be combined or may be integrated into another system, or some features may be ignored or not implemented.

The units described as separate components may or may not be physically separated. The components displayed as units may or may not be physical units, that is, may be located in one place or may be distributed among a plurality of network units. Some or all of the units may be selected according to actual needs to achieve the objective of the solutions of the disclosed embodiments.

Further, the various functional units in the disclosed embodiments of the present disclosure may be integrated into one processing unit, or each of these units may exist in separate locations physically, or two or more units may be integrated into one unit.

The foregoing embodiments are merely some specific embodiments or implementations of the present disclosure, but the protection scope of the present disclosure is not limited thereto. Within the technical scope disclosed in the present disclosure, a person skilled in the art may easily deviate other modifications or substitutions, all of which shall fall within the protection scope of the present disclosure. Accordingly, the protection scope of the present disclosure shall be subjected to the protection scope of the appended claims.

What is claimed is:

1. A computation apparatus for a neural network, comprising:
a first processing unit configured to perform a first computation on k1 number of input feature data according to a size of a computation window to obtain an intermediate result, wherein the size of the computation window is k1×k2, and k1 and k2 are positive integers; and
a second processing unit configured to perform a second computation on k2 number of intermediate results output by the first processing unit according to the size of the computation window to obtain a computation result.

2. The computation apparatus according to claim 1, wherein the computation apparatus includes M number of first processing units and M number of second processing units, the M number of first processing units and the M number of second processing units have a one-to-one correspondence, and M is a positive integer greater than 1; and
the computation apparatus further includes:
a preprocessing unit configured to receive an input feature matrix in columns, process received input feature values in a column according to the computation window to obtain M sets of data, and input the M sets of data one-to-one into the M number of first processing units, wherein each of the M sets of data includes k1 number of input feature values.

3. The computation apparatus according to claim 2, wherein:
a value of M is determined based on a size of the input feature matrix and the size of the computation window; and
the M sets of data include all data in the input feature values of the column.

4. The computation apparatus according to claim 2, wherein:
the M sets of data are a part of the input feature values in the column;
the preprocessing unit further includes a buffer; and
the preprocessing unit is further configured to store the remaining data, other than the M sets of data in the input feature values of the column, into the buffer.

5. The computation apparatus according to claim 1, wherein the computation window is a convolution window, a computation mode of the first computation is a multiply-accumulate operation, and a computation mode the second computation is an accumulation operation.

6. The computation apparatus according to claim 1, wherein the computation window is a pooling window, and a computation mode of the first computation is to find a maximum value or an average value, and a computation mode of the second computation is the same as the computation mode of the first computation.

7. The computation apparatus according to claim 2, wherein the input feature matrix represents a feature map segment in a to-be-processed image; and
the preprocessing unit is further configured to sequentially receive each feature map segment of the to-be-processed image.

8. A circuit for processing a neural network, comprising:
a first processing circuit configured to perform a first computation on k1 number of input feature data according to a size of a computation window to obtain an intermediate result, wherein a size of the computation window is k1×k2, and k1 and k2 are positive integers; and
a second processing circuit configured to perform a second computation on k2 number of intermediate results output by the first processing circuit according to the size of the computation window to obtain a computation result.

9. The circuit according to claim 8, wherein the circuit comprises M number of first processing circuits and M number of second processing circuits, the M number of first processing circuits and the M number of second processing circuits have a one-to-one correspondence, and M is a positive integer greater than 1; and
the circuit further includes:
a preprocessing circuit configured to receive an input feature matrix in columns, process received input feature values in a column according to the computation window to obtain M sets of data, and input the M sets of data one-to-one into the M number of first processing circuits, wherein each of the M sets of data includes k1 number of input feature values.

10. The circuit according to claim 9, wherein:
a value of M is determined based on a size of the input feature matrix and the size of the computation window; and
the M sets of data include all data in the input feature values of the column.

11. The circuit according to claim 9, wherein:
the M sets of data are a part of data in the input feature values of the column; and
the preprocessing circuit further includes a buffer;
the preprocessing circuit is further configured to store remaining data, other than the M sets of data in the input feature values of the column, into the buffer.

12. The circuit according to claim 8, wherein the computation window is a convolution window, a computation mode of the first computation is a multiply-accumulate operation, and a computation mode of the second computation is an accumulation operation.

13. The circuit according to claim 8, wherein the computation window is a pooling window, and a computation mode of the first computation is to find a maximum value or an average value, and a computation mode of the second computation is the same as that the computation mode of the first computation.

14. The circuit according to claim 9, wherein the input feature matrix represents a feature map segment in a to-be-processed image; and
the preprocessing circuit is further configured to sequentially receive each feature map segment of the to-be-processed image.

15. A method for processing a neural network, comprising:
performing a first computation on k1 number of input feature data according to a size of a computation window to obtain an intermediate result, wherein a size of the computation window is k1×k2, and k1 and k2 are both positive integers; and
performing a second computation on k2 number of intermediate results obtained by the first computation according to the size of the computation window to obtain a computation result.

16. The method according to claim 15, further comprising:
receiving an input feature matrix in columns, and processing received input feature values in a column according to the computation window to obtain M sets of data, wherein each of the M sets of data includes k1 number of input feature values;
wherein performing the first computation on the k1 number of input feature data according to the size of the computation window to obtain an intermediate result further includes:
performing the first computation on the M sets of data according to the size of the computation window to obtain corresponding intermediate results; and
wherein performing the second computation on the k2 number of intermediate results obtained by the first computation according to the size of the computation window further includes:
performing the second computation each time k2 number of intermediate results are obtained, from the first computation corresponding to each of the M sets of data, to obtain a corresponding computation result.

17. The method according to claim 16, wherein:
a value of M is determined based on a size of the input feature matrix and the size of the computation window; and
the M sets of data include all data in the input feature values of the column.

18. The method according to claim 16, wherein the M sets of data are a part of data in the input feature values of the column; and
the method further includes: storing remaining data, other than the M sets of data in the input feature values of the column, into a buffer.

19. The method according to claim 15, wherein the computation window is a convolution window, a computation mode of the first computation is a multiply-accumulate operation, and a computation mode of the second computation is an accumulation operation.

20. The method according to claim 15, wherein the computation window is a pooling window, a computation mode of the first computation is to find a maximum value or an average value, and a computation mode of the second computation is the same as the computation mode of the first computation.
